(19) United States
(12) Patent Application Publication
(10) Pub. No.: US 2003/0099257 A1
(43) Pub. Date: May 29, 2003

(54) Pre-delivery notification of user data for wireless packet data systems

(76) Inventors: Karl E. Freter, Wheaton, IL (US); Robert J. Marks, Homewood, IL (US); Ikhlaq Sidhu, Vernon Hills, IL (US); Timothy J. Wilson, Rolling Meadows, IL (US)

Correspondence Address: Welsh & Katz, Ltd., Jon P. Christensen, 22nd Floor, 120 South Riverside Plaza, Chicago, IL, 60606, US

(21) Appl. No.: 09/995,945

(22) Filed: Nov. 28, 2001

(51) Int. Cl. H04Q 7/00

(52) U.S. Cl. 370/477; 370/329

(57) ABSTRACT

A method and apparatus are provided for reducing delivery time latency in data transferred between a packet data service network and mobile data device. The method includes the steps of detecting an indicia of bandwidth needed for information to be transferred from the packet data service network to the mobile data device, comparing an attribute of the indicia with a predetermined criteria and notifying a wireless interface controller servicing the wireless data device when the attribute of the data block exceeds the predetermined file criteria.

### FIELD OF THE INVENTION

The field of the invention relates to wireless communication systems and more particularly to wireless data devices.

### BACKGROUND OF THE INVENTION

Mobile data devices (including wireless phones, Personal Data Assistants (PDAs) and mobile computers) are known. Such devices are typically provided with a screen for the display of data. Within the mobile data device, a windows-type operating system is often used. A graphical user interface (GUI) may be provided to reduce the need for external control keys and keyboards.

After a mobile data device is activated, it may transmit a data request to a wireless base station. The wireless base station may couple the request through a local Internet connection to the Internet destination. When a data response is received, the wireless base station may couple the data response back to the mobile data device.

It can be difficult for service providers to offer Internet services to mobile data devices. There are a number of reasons for this difficulty. For example, the wireless telephone system and the Internet are fundamentally different environments. Protocols and hardware developed for one environment are not always compatible with the other.

For example, communication resources within the wireless telephone system are typically assigned on an all-or-nothing basis. When a voice call is placed, a wireless user typically receives a radio channel for his use for the duration of a call. After the call, the channel may be given to someone else. Billing is usually accomplished by measuring the minutes that a user had exclusive possession of the channel.

Mobile data devices, on the other hand, may only require bandwidth for varying periods, and the timing of channel use may be very erratic. Further, the amount of data traffic may vary widely, requiring rapid adjustment of the traffic carrying capacity of a radio channel.

In order to reduce the overhead associated with short channel allocation, and to address the need for varying traffic load, wireless base stations often provide buffers for accumulating data directed to mobile data devices. Usually the wireless base station waits until the amount of buffered data exceeds a threshold or until a predetermined time period has passed before allocating appropriate radio channel resources for the transfer of data to the mobile data device.

When the amount of data directed to a mobile data device is relatively small, or arrives after a channel is released, the data must wait until either more data arrives or until another predetermined time period has expired. If the amount of data exceeds the traffic carrying capacity of the currently allocated radio channel, the excessive data must wait until additional radio channel capacity is allocated. In either case, delivery is delayed. Because delivery delay reduces the mobile data user's satisfaction, a need exists for a method of reducing data delivery delays.

### SUMMARY OF THE INVENTION

A method and apparatus are provided for reducing delivery time latency in data transferred between a packet data service network and mobile data device. The method includes the steps of detecting a data request from the mobile data device, comparing an attribute of the data request with a predetermined criteria and notifying a wireless base station servicing the mobile data device when the attribute of the data request matches the predetermined criteria. The method also includes the steps of detecting a data response from the packet data service network (e.g., the Internet), comparing an attribute of the data response with a predetermined criteria and notifying a wireless base station servicing the mobile data device when the attribute of the data response matches the predetermined criteria. The notification allows the wireless base station to allocate appropriate radio channel capacity prior to data delivery, so that data delivery delay is minimized.

### BRIEF DESCRIPTION OF THE DRAWINGS

FIG. 1 is a block diagram of a wireless packet data system in accordance with an illustrated embodiment of the invention; and

FIG. 2 is a block diagram of a packet data service node and wireless base station of the system of FIG. 1.

### DETAILED DESCRIPTION OF AN ILLUSTRATED EMBODIMENT

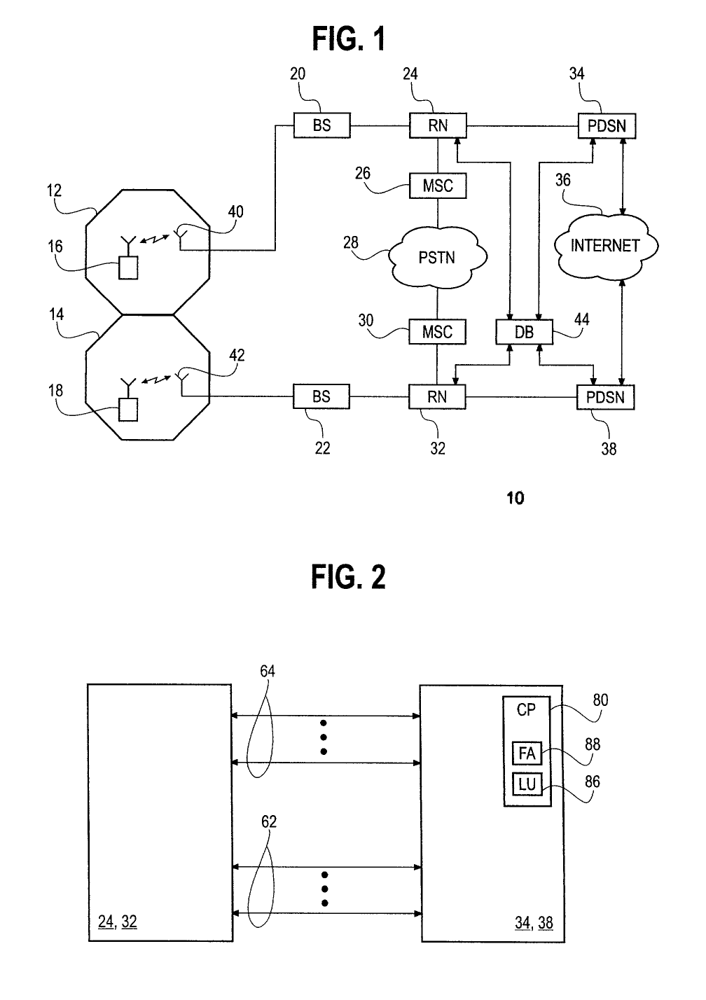

FIG. 1 depicts a wireless packet data system 10, shown generally in accordance with an illustrated embodiment of the invention. As shown, a mobile data device (MDD) 16, 18 may travel through different geographic areas 12, 14 and receive data services through a local antenna 40, 42 of the wireless base station (BS) 20, 22. As used herein, the acronym “MDD”refers to conventional PDAs and also to any other wireless device that has the data access, retrieval and display capabilities of a conventional PDA (e.g., appropriately equipped wireless telephones or pagers, personal computers with wireless interfaces, etc.). It is to be understood that a BS 20, 22 may contain a packet data control interface or use an external packet data control interface (e.g., a packet control function node) to communicate with a packet data serving node (PDSN) 34, 38. Further, the wireless packet data system 10 may be based upon any appropriate frequency use plan (e.g., FDM, TDM, CDMA, etc.).

While the wireless packet data system 10 will be described in terms of wireless services offered within the U.S., it is to be understood that the wireless packet data system 10 may also be implemented within the wireless systems of other countries (e.g., GSM in Europe, JTACS in Japan, etc.). For example, a GGSN is an equivalent packet data services node used in conjunction with GPRS, a wireless packet data system for GSM. It is also to be understood that the descriptive terms used herein are intended to include the corresponding processes and structure of the wireless systems of other countries.

To access data services within the U.S. wireless system, a MDD 16, 18 may transmit an access request for packet data service to a BS 20, 22.

The BS 20, 22 may transfer the request, (including the identifier of the MDD 16, 18) to an associated PDSN 34, 38.

In order to facilitate transfer of the access request (and support the exchange of information, in general), a number of communication links 62, 64 (FIG. 2) may exist between the BS 20, 22 and PDSN 34, 38 of the system 10. Some of the links 64 may be set up as temporary connections, as needed, in support of a granted access request from the MDD 16, 18.

Other links 62 may be established as relatively permanent connections upon start-up of the BS 20, 22 and PDSN 34, 38. The permanent connections 62 may exist for the exchange of control information and for transfer of access requests to the PDSN 34, 38 from the MDD 16, 18.

Within the PDSN 34, 38, an access request received from the MDD 16, 18 may be analyzed by a communications processor (CP) 80 and processed accordingly. The CP 80 may send a response to the BS 20, 22 granting access to the MDD 16, 18. The BS 20, 22 may then establish a link 64 to carry data requests and data responses between the MDD 16, 18 and PDSN 34, 38.

Once the MDD 16, 18 has been granted access, the MDD 16, 18 may compose and forward a data request (e.g., an IP packet) to the BS 20, 22. The data request may include the identifier of the MDD 16, 18 and an indicator of the type of request. The BS 20, 22 may forward the data request using the link 64 to the PDSN 34, 38.

Within the PDSN 34, 38, the CP 80 may receive and examine the contents of the data request. From the data request, or from the identity of the link 64 providing the data request, the CP 80 may determine whether or not it should analyze the data request to determine if the request matches some predetermined criteria relating to the communication channel with the MDD.

Subsequently the CP 80 may transfer the data request to the Internet destination 36. The CP 80 may also maintain a cache memory 86 for frequently accessed Internet information. Where the CPU 80 recognizes the Internet destination of the data request as being directed to previously cached information, the CP 80 may retrieve the information locally rather than from the Internet destination.

In due course, whether from its local cache or from the Internet destination, a data response may be received by the PDSN 34, 38. From the data response, or from the identity of the link 64 that will be used to carry the data response, the CP 80 may determine whether or not it should analyze the data response to determine if the request matches some predetermined criteria relating to the communication channel with the MDD.

In order to facilitate delivery of data traffic to MDDs 16, 18, a PDSN 34, 38 may analyze data requests and responses for indicia of bandwidth. As used herein, indicia of bandwidth means an identifier of an application or protocol used in transferring information to the mobile data device or an actual size of a data block to be send to the mobile data device.

An analyzer 88 within the CP 80 may identify attributes of the indicia of bandwidth found within data requests and compare the identified attributes with a predetermined criteria (e.g., application type, protocol type, etc.). The analyzer 88 within the CP 80 may also analyze attributes of data responses based upon a predetermined criteria (e.g., data traffic amount, etc.). Where an attribute of the data request or data response matches or exceeds the predetermined criteria, the PDSN 34, 38 may use a control link 62 to notify the BS 20, 22 of the attribute matching the predetermined criteria. It is also to be understood that a data traffic amount exceeding the amount specified by the predetermined criteria for the indicia of bandwidth will also be recognized as a match. Notification may occur in advance of or contemporaneously with data traffic delivery.

Advance notification reduces data delivery latency by allowing radio channel capacity to be preallocated for delivery of the data traffic to the MDD. When latency is reduced, the end user experiences higher throughput and reduced response times.

In a typical wireless packet data system, data accumulates at the BS 20, 22 before the BS 20, 22 schedules its transmission over a radio channel to the MDD 16, 18. Generally, the BS 20, 22 bases scheduling decisions on the amount of data waiting to be sent to the MDD 16, 18. A system that can allocate additional radio channels (or radio channel bandwidth) for data delivery decides when additional radio resources are needed based upon the amount of data waiting to be sent to the MDD 16, 18.

When scheduling is based upon data backlog, as under the prior art, latency is increased, as the data must first sit in a buffer while the backlog increases before it can be scheduled for transmission to the MDD 16, 18. In addition, scheduling will be somewhat imprecise, since it must operate using a snapshot of the backlog (as input to the scheduling decision maker), and the backlog will likely vary over time.

The invention improves a wireless packet data system's scheduling ability by giving the system 10 advance notification of data being sent to the MDD 16, 18. The notification provided may include an estimate of the amount of data being sent. Using the advance notification provided, the system 10 can schedule transmission of the data before the data backlog increases, thus greatly reducing latency, improving efficiency, and enhancing the end user's experience.

The notification provided may also be used as an indicator that a particular application or protocol is being requested or used. Using the advance notification provided, the system 10 can pre-allocate appropriate radio channel capacity consistent with the needs of the indicated application or protocol, thus providing the benefits described above.

In order to provide notification of delivery, the analyzer 88 may perform a number of tests to determine whether the data request or data response matches the predetermined criteria. The data request or data response may indicate the particular application (e.g., File Transfer Protocol (FTP)) or protocol (e.g., Real Time Protocol (RTP)) being requested or used. The data response may indicate the amount of data traffic being sent to the MDD 16, 18.

Where the system 10 is based upon fixed capacity radio channels, one or more radio channels may be allocated by the BS 20, 22 as appropriate to the situation. Where the system 10 uses expandable radio channels (e.g., CDMA2000), the radio channel bandwidth to the MDD 16, 18 may be expanded as necessary to meet the needs of the data traffic.

Based upon the advance notification from the PDSN 34, 38, pre-delivery allocation allows data traffic to be immediately channeled to the user without delay. Where the wireless interface is congested by prior users, the advance notification may be used as additional information by the scheduler to more accurately perform its scheduling function.

A specific embodiment of a method and apparatus for delivery of notification of user data for wireless packet data systems according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of reducing delivery time latency of data transferred between a packet data service node system and a mobile data device, such method comprising the steps of:
detecting an indicia of bandwidth for transferring information from the packet data service node system to the mobile data device;
comparing an attribute of the indicia with a predetermined criteria; and
notifying a wireless interface controller servicing the wireless data device when the attribute of the data block exceeds the predetermined file criteria.

2. The method of reducing delivery time latency as in claim 1 wherein the step of detecting the indicia of bandwidth further comprises detecting an access request under a real time protocol.

3. The method of reducing delivery time latency as in claim 1 wherein the step of detecting the indicia of bandwidth further comprises detecting an access request under a file transfer protocol.

4. The method of reducing delivery time latency as in claim 1 wherein the step of detecting the indicia of bandwidth further comprises detecting a size of a data block to be transferred to the mobile data device.

5. The method of reducing delivery time latency as in claim 1 wherein the step of notifying the wireless interface controller further comprises sending a notification message from the packet data service network to the wireless interface controller.

6. The method of reducing delivery time latency as in claim 1 further comprising appending the notification to a header of the data block.

7. The method of reducing delivery time latency as in claim 1 further comprising composing a packet message of the notification.

8. The method of reducing delivery time latency as in claim 7 further comprising retrieving a network address of the wireless interface controller.

9. The method of reducing delivery time latency as in claim 8 further comprising addressing the packet message to the retrieved network address.

10. The method of reducing delivery time latency as in claim 9 further comprising appending an identifier of the mobile data device to the packet message.

11. The method of reducing delivery time latency as in claim 1 further comprising transferring the data block from the packet data service network to the wireless interface controller.

12. The method of reducing delivery time latency as in claim 11 further comprising allocating a portion of a bandwidth of a wireless interface betw een the wireless interface controller and mobile data device for transfer of the data block.

13. An apparatus for reducing delivery time latency of data transferred between a packet data service node system and a mobile data device, such apparatus comprising:
means for detecting an indicia of bandwidth for transferring information from the packet data service node system to the mobile data device;
means for comparing an attribute of the indicia with a predetermined criteria; and
means for notifying a wireless interface controller servicing the wireless data device when the attribute of the data block exceeds the predetermined file criteria.

14. The apparatus for reducing delivery time latency as in claim 13 wherein the means for notifying the wireless interface controller further comprises means for sending a notification message from the packet data service network to the wireless interface controller.

15. The apparatus for reducing delivery time latency as in claim 13 further comprising means for appending the notification to a header of the data block.

16. The apparatus for reducing delivery time latency as in claim 13 further comprising means for composing a packet message of the notification.

17. The apparatus for reducing delivery time latency as in claim 16 further comprising means for retrieving a network address of the wireless interface controller.

18. The apparatus for reducing delivery time latency as in claim 17 further comprising means for addressing the packet message to the retrieved network address.

19. The apparatus for reducing delivery time latency as in claim 18 further comprising means for appending an identifier of the mobile data device to the packet message.

20. The apparatus for reducing delivery time latency as in claim 13 further comprising means for transferring the data block from the packet data service network to the wireless interface controller.

21. The apparatus for reducing delivery time latency as in claim 20 further comprising means for allocating a portion of a bandwidth of a wireless interface between the wireless interface controller and mobile data device for transfer of the data block.

22. An apparatus for reducing delivery time latency of data transferred between a packet data service node system and a mobile data device, such apparatus comprising:
a routing processor adapted to detect an indicia of bandwidth for transferring information from the packet data service node system to the mobile data device;
a file analyzer adapted to compare an attribute of the indicia with a predetermined criteria; and
a communications processor adapted to notify a wireless interface controller servicing the wireless data device when the attribute of the data block exceeds the predetermined file criteria.

23. The apparatus for reducing delivery time latency as in claim 22 wherein the communications processor further comprises a data link adapted to send a notification message from the packet data service network to the wireless interface controller.

24. The apparatus for reducing delivery time latency as in claim 22 further comprising a memory adapted to retrieve a network address of the wireless interface controller.

25. The apparatus for reducing delivery time latency as in claim 22 further comprising a client application adapted to transfer the data block from the packet data service network to the wireless interface controller.
